(19) United States
(12) Patent Application Publication
(10) Pub. No.: US 2013/0030885 A1
(43) Pub. Date: Jan. 31, 2013

(54) SYSTEM AND METHOD FOR GLOBAL GROUP PURCHASE SERVICE ON FIRST-COME-FIRST-SERVED BASIS

(71) Applicants: Gyuseok LEE, Seoul (KR); Yong Ho AN, Yongin-si (KR)

(72) Inventors: Gyuseok LEE, Seoul (KR); Yong Ho AN, Yongin-si (KR)

(21) Appl. No.: 13/247,865

(22) Filed: Sep. 28, 2011

(30) Foreign Application Priority Data
Jul. 27, 2011 (KR) 10-2011-0074653

(51) Int. Cl. G06Q 30/02

(52) U.S. Cl. 705/14.1

(57) ABSTRACT

A system and method provide a group purchase service in which a discount rate is applied differentially depending on the group purchase volume on first-come-first-served basis. In the group purchase service, a central server determines a discount policy such that each local server applies differential discount rates in group purchase rounds depending on group purchase volumes of an item in a purchase process performed by buyer devices. When each of the buyer devices accesses the local server in each service area and performs the purchase process for the item through the local server, the local server applies the differential discount rates to the rounds depending on the group purchase volumes of the item. When the sales deadline arrives or when all the items sold out, the central server applies a final discount rate according to a totalization of the group purchase volumes in all the service areas

### CROSS REFERENCES

Applicant claims foreign priority under Paris Convention and 35 U.S.C. §119 to Korean Patent Application No. 10-2011-0074653, filed Jul. 27, 2011, with the Korean Intellectual Property Office, where the entire contents are incorporated herein by reference.

### BACKGROUND OF THE INVENTION

1. Field of the Invention

The present invention relates generally to group purchase service technology and, more particularly, to a system and method for providing a group purchase service in which a discount rate is applied differentially depending on the group purchase volume on first-come-first-served basis.

2. Description of the Related Art

With remarkable growths of internet technology, online purchase services based on electronic commerce are increasingly popularized in these days. Some of these purchase services are to quote in advance a lower price for limited quantities of selling items than the open market price and then to receive buyers' offers.

These conventional purchase services rely on a seller-oriented system in which sellers predetermine selling prices and then uniformly apply them regardless of purchase volumes. Therefore, buyers' intentions are not reflected in these services, and further, it is difficult to expect cumulative discount effects even though purchase volumes increase. Additionally, since these services are restrictively provided for a single web site or nation alone, the advantages of volume sales at a low margin of profit are not sufficiently maximized.

### BRIEF SUMMARY OF THE INVENTION

Accordingly, the present invention is to address the above-mentioned problems and/or disadvantages and to offer at least the advantages described below.

One aspect of the present invention is to realize a system and method for providing a group purchase service in which a discount rate is applied differentially depending on the group purchase volume on first-come-first-served basis.

Another aspect of the present invention is to provide an electronic commerce business model that allows real-time global trade through group purchase or wholesale based on Internet or mobile devices between nations or regions without requiring any actual movement between nations or regions.

Still another aspect of the present invention is to provide a business model that causes a great discount through mega-demand or mega-group purchasing aggregation on first-come-first-served basis between nations or regions.

Yet another aspect of the present invention is to allow mass purchase through real-time integration of global group purchase by overcoming typical group purchase based on regional limitations and therefore to propose a new global trade paradigm with the maximum discounts due to volume sales at a low margin of profit.

Further another aspect of the present invention is to collectively perform international distribution processes such as delivery and tariff for the same item in the same nation/region.

Further another aspect of the present invention is to provide a particular business model realized in the form of a combination of online and offline rather than a simple online relay.

According to one aspect of the present invention, provided is a group purchase service system comprising: local servers respectively located in different service areas; buyer devices each of which accesses the local server in the service area and performs a purchase process for a desired item through the local server; and a central server configured to determine a discount policy such that each local server applies differential discount rates to group purchase rounds depending on group purchase volumes of the item in the purchase process performed by the buyer devices, and to apply a final discount rate according to a totalization of the group purchase volumes in all the service areas when a predefined sales deadline arrives or when all the items sold out.

In this system, the final discount rate may be greater than or equal to the differential discount rates.

In this system, each of the local servers may apply the differential discount rates whenever each of the group purchase volumes predetermined for the rounds is exceeded.

In this system, the central server may equally apply the final discount rate to all purchases of the item when the totalization of the group purchase volumes reaches a given value.

In this system, the service areas may be defined relying on at least of nations, regions, specific service zones of network operators, and marketplaces.

In this system, the group purchase volumes may be totalized on first-come-first-served basis according to the service areas or individual buyers.

This system may further comprise seller devices each of which accesses the local server in the service area and registers the item in the local server.

In this system, one of the central server and the seller device may entrust at least one of delivery and tariff tasks for the item to the local servers.

According to another aspect of the present invention, provided is a group purchase service method comprising: at a central server, determining a discount policy such that each local server applies differential discount rates in group purchase rounds depending on group purchase volumes of an item in a purchase process performed by buyer devices; when each of the buyer devices accesses the local server in each service area and performs the purchase process for the item through the local server, at the local server, applying the differential discount rates to the rounds depending on the group purchase volumes of the item; at the central server, determining whether a predefined sales deadline arrives and whether all the items sold out; and when the sales deadline arrives or when all the items sold out, at the central server, applying a final discount rate according to a totalization of the group purchase volumes in all the service areas.

In this method, the final discount rate may be greater than or equal to the differential discount rates.

In this method, each of the local servers may apply the differential discount rates whenever each of the group purchase volumes predetermined for the rounds is exceeded.

In this method, the central server may equally apply the final discount rate to all purchases of the item when the totalization of the group purchase volumes reaches a given value.

In this method, the service areas may be defined relying on at least of nations, regions, specific service zones of network operators, and marketplaces.

In this method, the group purchase volumes may be totalized on first-come-first-served basis according to the service areas or individual buyers.

This method may further comprise, when each of seller devices accesses the local server in the service area and registers the item in the local server, at the central server, receiving item registration information from the local server.

This method may further comprise, at one of the central server and the seller device, entrusting at least one of delivery and tariff tasks for the item to the local servers.

The group purchase service of the present invention determines a discount rate for each round of group purchase by totalizing real-time purchase volumes of each service area, allows all service areas to share related information such as group purchase volumes, the rate of increase, and discount rates in each service area, and determines a global discount rate based on real-time totalization of group purchase volumes in all service areas. Therefore, the group purchase service of this invention allows all buyers in different service areas to benefit by the same global discount rate.

Additionally, the group purchase service of the present invention further provides a final discount rate, newly determined by final totalization of group purchase volumes, to earlier buyers. This may lead to sales promotion by inducing buyers to carry out quick purchases.

Furthermore, the group purchase service of the present invention applies the same discount rate based on totalization of group purchase volumes in all service areas without being limited to a specific marketplace, nation, region, etc., thus realizing a real-time global group purchase with reduction in price.

Also, when there are different languages used in service areas, the group purchase service of the present invention may provide information about selling items by means of suitably translated languages.

And also, the group purchase service of the present invention may collectively perform international distribution processes for the same nation/region/item, including delivery and tariff, which have been performed for buyer individuals.

After all, the present invention may provide a particular business model realized in the form of a combination of online and offline rather than a simple online relay.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a block diagram illustrating a group purchase service system in accordance with an exemplary embodiment of the present invention.

FIG. 2 is a flow diagram illustrating a group purchase service method in accordance with an exemplary embodiment of the present invention.

FIGS. 3A and 3B are views illustrating modes of determining a discount rate for a group purchase service in accordance with an exemplary embodiment of the present invention.

FIG. 4 is a view illustrating a mode of determining a discount rate for a group purchase service in accordance with another exemplary embodiment of the present invention.

FIG. 5 is a schematic view illustrating a group purchase service method in accordance with still another exemplary embodiment of the present invention.

### DETAILED DESCRIPTION OF THE INVENTION

Exemplary, non-limiting embodiments of the present invention will now be described more fully with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

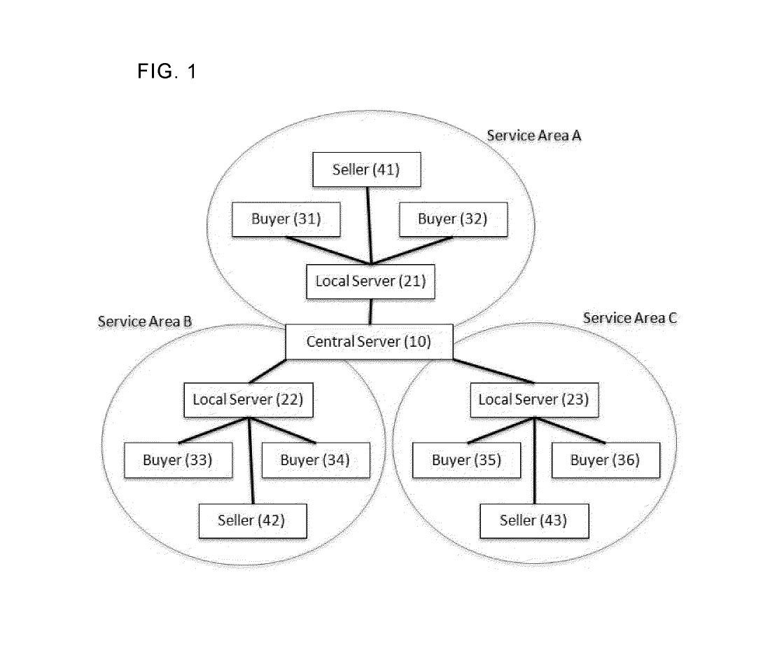

FIG. 1 is a block diagram illustrating a group purchase service system in accordance with an exemplary embodiment of the present invention.

The group purchase service system is composed of a central server 10 and a plurality of local servers 21, 22 and 23. The respective local servers 21, 22 and 23 are located in different service areas A, B and C in order to locally provide a group purchase service. These service areas may be defined relying on nations, regions, specific service zones of network operators, or the like. For example, the service areas A, B and C may be Korea, USA and Spain, or the East, Middle West or West of USA. This is, however, exemplary only and not to be considered as a limitation of the present invention.

Additionally, the group purchase service system may further include a plurality of buyer devices 31˜36 and a plurality of seller devices 41˜43. Each of such devices 31˜36 and 41˜43 is located in one of the service areas A˜C and may have access to corresponding one of the local servers 21˜23. Namely, buyers can use a group purchase service by using their own devices 31˜36 each of which is capable of accessing, through a network, the local server 21˜23 covering the current service area A˜C. Similarly, sellers can use the same group purchase service by using their own devices 41˜43 each of which is capable of accessing the local server 21˜23 through a network.

The central server 10 controls all of the local servers 21˜23 and provides a real-time global-based group purchase service that is not limited to a specific service area. The central server 10 and the local servers 21˜23 may be physically separated as different devices or logically divided in a single device. Alternatively, the central server 10 may provide different URLs (Uniform Resource Locators) and related mobile applications for respective service areas so that the local servers may be replaced by them. Here, each URL represents a group purchase site in each service area.

The group purchase service of this invention may be provided in the form of a marketplace (e.g., e-marketplace). Namely, the central server 10 or the local servers 21˜23 may provide marketplaces as a particular interface in which sellers can register selling items and buyers can buy desired items. Each marketplace corresponds to each service area. Such marketplaces may be formed of web pages.

The central server 10 and the local servers 21˜23 reside in a communication network. The buyer devices 31˜36 and the seller devices 41˜43 may access the local servers 21˜23 through the network. For instance, this network may be a fixed access type network such as a DSL (Digital Subscriber Line), a cable modem, Ethernet, or the like. In this type, the network may provide a wired communication service so that the buyer devices 31˜36 may access the local servers 21˜23 through a modem, a router, a gateway, etc. Also, the network may be a mobile access type network such as W-CDMA (Wideband Code Division Multiple Access), CDMA2000, GSM (Global System for Mobile communication), GPRS (General Packet Radio Service), LTE (Long Term Evolution), LTE-Advanced, etc. In this type, the network has base stations, base station controllers and gateways and provides a wireless communication service to the buyer devices 31˜36 so that the buyer devices 31˜36 may access the local servers 21˜23. And also, the network may be a wireless access type network such as WLAN (Wireless Local Area Network), WiFi (Wireless Fidelity), WIMAX (Worldwide Interoperability for Microwave Access), etc. In this type, the network has access points and access routers and provides a wireless communication service to the buyer devices 31˜36 so that the buyer devices 31˜36 may access the local servers 21˜23.

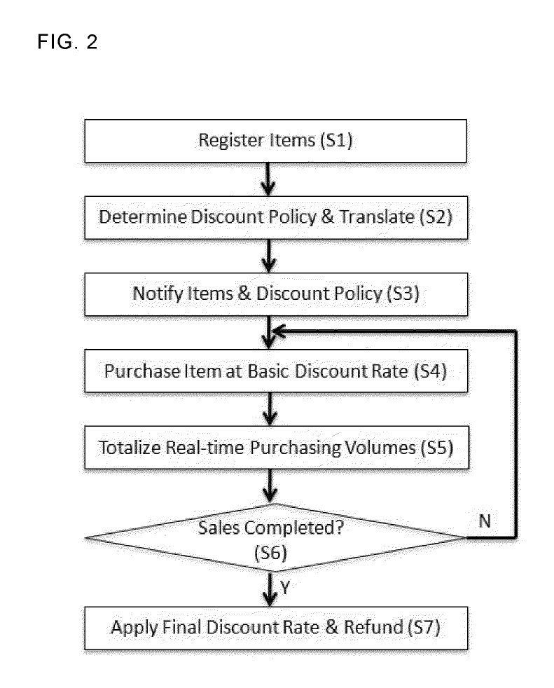

FIG. 2 is a flow diagram illustrating a group purchase service method in accordance with an exemplary embodiment of the present invention.

Referring to FIGS. 1 and 2, each buyer devices 41˜43 may access the local server 21˜23 in its own service area A˜C and then register selling items in the local server (step S1). Registration is to input information about desired items to be sold such as item names, item numbers, selling prices, launching time, and the like. Such item registration information is stored in the local servers 21˜23 and also provided to the central server 10. In this step, the local servers 21˜23 may provide a marketplace, as an interface for registering items, to the seller devices 41˜43. Therefore, using their own devices 41˜43, sellers can access the local servers 21˜23 through the network and register items through the marketplace.

After items are registered, the central server 10 determines a discount policy (step S2). This discount policy defines different discount rates for different rounds based on the group purchase volume. Namely, the discount policy designates discount rates differentially applied to group purchase rounds according to increases in the group purchase volume. For instance, a discount rate is 10% when the group purchase volume for a specific item reaches one hundred, and a discount rate is 20% when the group purchase volume reaches two hundreds. Detailed descriptions will be made below. In this step, the central server 10 may further determine a way of totalizing the group purchase volume to be used for determining discount rates. For instance, the sum of purchase volumes by service areas or by individual buyers may be totalized as the group purchase volume. Detailed descriptions will be made below. In this step, the central server 10 may translate registration information about items into specific languages used in the respective service areas A˜C. Alternatively, each local server 21˜23 may perform this language translation.

After the discount policy is determined, the central server 10 sends the discount policy to the local servers 21˜23 and then each local server 21˜23 notifies the registered item information and the received discount policy (step S3). Here, a notification of items and discount policy is given through a marketplace provided by each local server 21˜23.

The buyer devices 31˜36 in the service areas A˜C may access the local servers 21˜23, check a notification of items and discount policy, and then perform a purchase process for a desired item (step S4). A sale in this group purchase round is based on the first discount rate applied according to purchase volumes.

Additionally, purchase information in each of the service areas A˜C is instantly sent to the central server 10, and then the central server 10 totalizes the real-time group purchase volumes by collecting purchase information received from each local server 21˜23 (step S5).

Also, the central server 10 determines whether sales completion conditions are satisfied (step S6). The sales completion conditions include the arrival of a sales deadline and desired items sold-out. In case of no sales completion, namely, if the sales deadline is not yet arrived and if selected items are not yet sold out, the purchase process in the aforesaid step S4 is continued. Here, the central server 10 provides the group purchase volume totalized in the above step S5 to the local servers 21˜23, and then the local servers 21˜23 apply a discount rate that may be varied according to the group purchase volume.

Meanwhile, in case of a sales completion, namely, if the sales deadline is arrived or if selected items are sold out, the central server 10 notifies a sales completion to the local servers 21˜23 and then applies the final discount rate (step S7). Also, depending on the final discount rate, the central server 10 refunds the balance of discount to buyers required to be repaid.

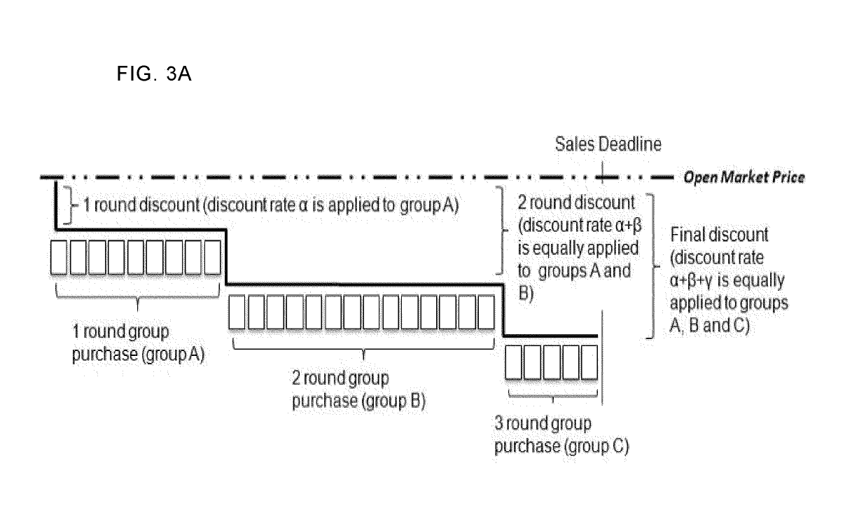

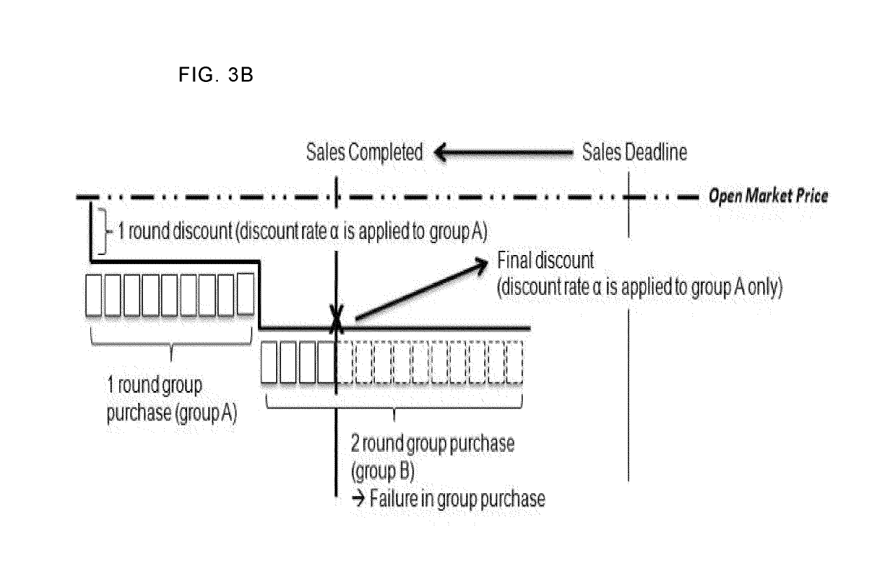

FIGS. 3A and 3B are views illustrating modes of determining a discount rate for a group purchase service in accordance with an exemplary embodiment of the present invention.

Basically, the group purchase service of this invention has a structure of a decreasing price, i.e., an increasing discount rate, based on the group purchase volume. Namely, as the group purchase volume increases, a selling price decreases by rounds proportionate to the group purchase volume. This mode of the invention is different from one typical mode of collectively applying a predefined discount rate when the given volume of group purchase is reached, and from another typical mode of gradually applying predefined discount rates by given purchase sections. For instance, the former mode is to apply a 20% discount rate when the group purchase volume reaches 200 pieces, and the latter mode is to apply a 10% discount rate at the group purchase volume of 100 pieces or less and to apply a 20% discount rate at the group purchase volume from 101 to 200 pieces. Namely, when the group purchase volume is in a certain section, these modes are to apply a predefined discount rate for that section.

However, a mode of determining a discount rate in this invention is to apply a 10% discount rate at the group purchase volume of 100 pieces and then to apply a 20% discount rate at the group purchase volume of 200 pieces. Particularly, when the group purchase volume reaches 200 pieces, a 20% discount rate is newly applied to a previous group purchase to which a 10% discount rate has been applied.

The above discussed modes will be compared to each other under the same conditions. Let's suppose that the first buyer A purchases 100 pieces of item, the second buyer B purchases 70 pieces of item, and then the third buyer C purchases 30 pieces of item. Table 1 given below shows discount rates applied to these buyers according to the above modes.

TABLE 1

| | Former Mode | | | Latter Mode | | | Invention | | |
|---|---|---|---|---|---|---|---|---|---|
| Buyer | A | B | C | A | B | C | A | B | C |
| Purchase Volume | 100 | 70 | 30 | 100 | 70 | 30 | 100 | 70 | 30 |
| Discount Rate (%) | 0 | 0 | 20 | 10 | 20 | 20 | 20 | 20 | 20 |

Referring to FIG. 3A, a mode of determining a discount rate in this invention is as follows. Let's suppose that all articles are sold out in the form of a group purchase through three rounds before a sales deadline. In this case, a discount rate of each round is cumulatively applied to all group purchases of three rounds. Specifically, if a discount rate in each of three rounds is 10%, a discount rate applied to a group purchase sold in the first round is 10%, a discount rate applied to a group purchase sold in the second round is 20% which is made by 10% added to a 10% discount rate in the first round, and a discount rate applied to a group purchase sold in the third round is 30% which is made by 10% added to a 20% discount rate in the second round. However, after a group purchase in the third round, a 30% discount rate in the third round is equally applied to all previous group purchases in the first and second rounds.

Meanwhile, referring to FIG. 3B, if the group purchase volume in the first round is exceeded but the group purchase volume in the second round is not exceeded till a sales deadline, a discount rate of the first round is applied to a group purchase in the first round only.

The group purchase service of this invention may apply the same discount rate to a group purchase for different items as well as for the same items.

As discussed above, the group purchase service of this invention determines a discount rate for each round of group purchase by totalizing real-time purchase volumes of each service area. Also, the group purchase service of this invention allows all service areas to share related information such as group purchase volumes, the rate of increase, and discount rates in each service area, and determines a global discount rate based on real-time totalization of group purchase volumes in all service areas. Therefore, the group purchase service of this invention allows all buyers in different service areas to benefit by the same global discount rate.

Additionally, although different discount rates are applied in different group purchase rounds, the group purchase service of this invention applies again the maximum discount rate to all previous group purchase rounds at the time of final purchase (namely, at the sales deadline). Therefore, all global buyers can be benefited by a greater discount rate or at least the same discount rate on the basis of the global group purchase volume instead of a discount rate equally applied to each service area. Namely, the group purchase service of this invention respectively applies 1, 2, 3, . . . , and N-th discount rates to group purchase rounds according to variations in the group purchase volume in each service area, and then newly applies 1+α, 2+β, 3+γ, . . . , and N+δ-th discount rates greater than or equal to a discount rate of each service area by totalizing the real-time group purchase volumes in all service areas.

In one example, let's suppose that basic discount rates are 10% for 100 pieces of group purchase, 20% for 200 pieces of group purchase, . . . , and 50% for 500 pieces of group purchase. Namely, let's suppose that a 10% discount rate for 100 pieces is applied to each round. Additionally, let's suppose that the group purchase volumes are 100 pieces in the service area A, 80 pieces in the service area B, and 120 pieces in the service area C as the result of totalization at the sales deadline. In this case, a basic discount rate of 10% is first applied to a group purchase in the service area A. Since a group purchase in the service area B does not exceed 100 pieces, a discount rate of 0% is first applied and therefore a group purchase results in a failure. Also, a basic discount rate of 10% is first applied to a group purchase in the service area C. By the way, since the sum of all group purchases in the service areas A, B and C is 300 pieces, a global discount rate of 30% is finally and equally applied to all group purchases in the service areas A, B and C.

In another example, let's suppose that a 10% discount rate for 100 pieces is applied to each round. Additionally, let's suppose that the group purchase volumes are 100 pieces in the service area A, 30 pieces in the service area B, and 20 pieces in the service area C as the result of totalization at the sales deadline. In this case, a discount rate of 10% is first applied to a group purchase in the service area A. Since a group purchase in the service area B does not exceed 100 pieces, a discount rate of 0% is first applied and therefore a group purchase results in a failure. Similarly, since a group purchase in the service area C does not exceed 100 pieces, a discount rate of 0% is first applied and a group purchase results in a failure. Since the sum of all group purchases in the service areas A, B and C is 150 pieces, a global discount rate of 10% is finally and equally applied to all group purchases in the service areas A, B and C.

Preferably, a seller may notify a selling price to which the same discount rate is applied in every service area. However, a selling price may be varied according to service areas in consideration for properties of each service area (e.g., day air courier, 30 days shipping delivery, etc.) and types of payment (e.g., credit card, paypal, cash transfer, point purchase, etc.).

Basically, the group purchase service of this invention is implemented on first-come-first-served basis. In order to determine a discount rate, the totalization of the group purchase volume may be performed on first-come-first-served basis by service areas or by individual buyers.

First-come-first-served basis by service areas is to apply a discount rate from any service area that reaches first the given group purchase volume. For instance, let's suppose that 80 pieces, 30 pieces, 10 pieces and 20 pieces are sold respectively and sequentially in the service areas A, B, C and A when a 20% discount rate is applied for sales volume of 100 pieces. In this case, since the service area A reaches first the group purchase of 100 pieces, a 20% discount rate is applied to a group purchase in the service area A.

First-come-first-served basis by individual buyers is to apply a discount rate from any buyer that reaches first the given group purchase volume. For instance, let's suppose that 80 pieces, 30 pieces, 10 pieces and 20 pieces are sold respectively and sequentially to the first buyer in the service area A, the second buyer in the service area B, the third buyer in the service area C, and the fourth buyer in the service area A when a 20% discount rate is applied for sales volume of 100 pieces. In this case, a 20% discount rate is applied to 80 pieces of the first buyer and 20 pieces only among 30 pieces of the second buyer.

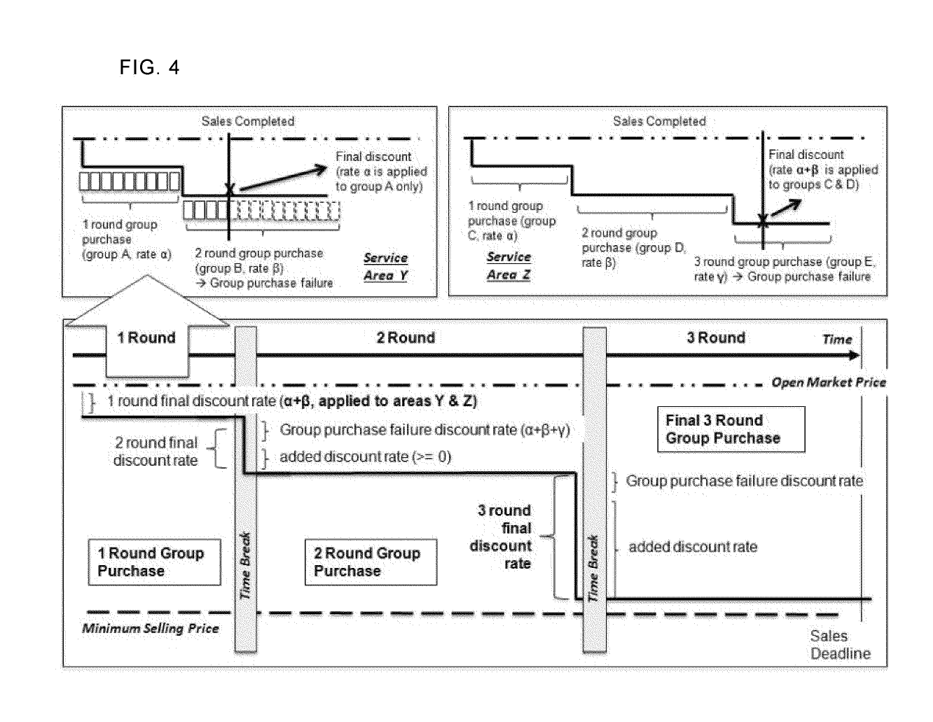

FIG. 4 is a view illustrating a mode of determining a discount rate for a group purchase service in accordance with another exemplary embodiment of the present invention.

Referring to FIG. 4, in case of failure in group purchase, a higher secondary discount rate may be proposed to buyers. This secondary discount rate may be determined according to parameters such as sold volume, stock volume, current time, and sales deadline. For instance, a secondary discount rate increases as stock volume is greater than sold volume and as current time approaches sales deadline. However, a secondary discount rate may not exceed a specific discount rate predetermined by a seller.

According to some embodiments of this invention, in case of failure in group purchase, the local servers 21˜23 may treat all buyers, trying to make group purchase but failing to attain a given volume of group purchase, as potential buyers. Then, targeting such potential buyers, the local servers may advertise next group purchase with a higher discount rate through e-mail, SMS (short message service), or the like.

According to some embodiments of this invention, buyers may recommend a marketplace to their friends, etc. by sending its address (e.g., URL) through various types of social networks or equivalents. Also, from sales based on their recommendations, buyers may receive incentives such as cash-back or cash point. Contrary to a typical multilevel selling in which cash or point is determined according to depth in the entire hierarchy, cash or point in this invention is given for purchase in the first relation with a recommender. For instance, if a buyer A forms the first relations with B, C and D and also if a buyer B forms the first relations with E and F, cash or point is given to A only for purchase of B, C or D, and to B only for purchase of E or F.

According to some embodiments of this invention, before the group purchase by rounds is started, sellers may propose the open market price, the sales deadline, discounted selling prices or discount rates by rounds, and the minimum selling price or the maximum discount rate. The closing of group purchase is made when all items are sold out or when the sales deadline arrives.

As discussed above, this invention provides an electronic commerce business model that allows real-time global trade through group purchase or wholesale based on Internet or mobile devices between nations or regions without requiring any actual movement between nations or regions.

Particularly, this invention provides a business model that causes a great discount through mega-demand or mega-group purchasing aggregation on first-come-first-served basis between nations or regions.

Additionally, this invention allows mass purchase through real-time integration of global group purchase by overcoming typical group purchase based on regional limitations. Therefore, this invention proposes a new global trade paradigm with the maximum discounts due to volume sales at a low margin of profit.

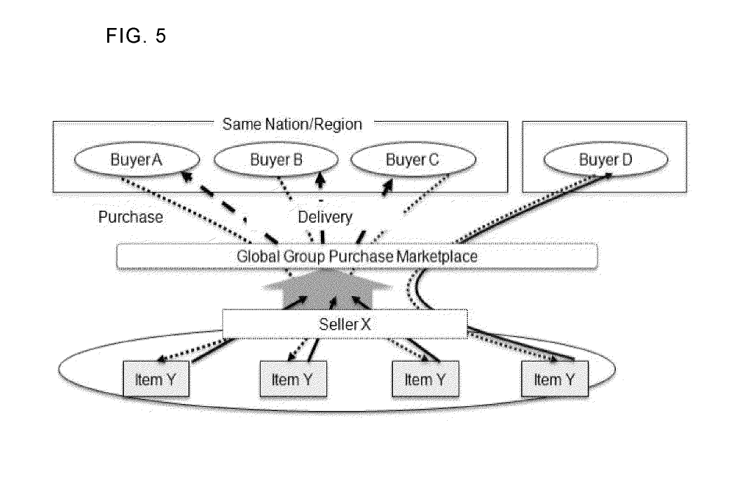

Meanwhile, after the above-discussed global group purchase, this invention may realize a global electronic commerce based on a combination of online and offline by further performing an offline business for international distribution including common delivery and tariff for nations/regions, not for buyer individuals. In connection with this, FIG. 5 is a schematic view illustrating a group purchase service method in accordance with still another exemplary embodiment of the present invention.

A conventional electronic commerce service performs only a role of intermediary between buyers and sellers at online marketplaces without bearing the responsibility for physical distribution of items including delivery and tariff between nations or regions. This may, however, cause an increase in distribution cost and inconvenience of buyers. For instance, if each of a hundred of Korean buyers buys one piece of the same item from American seller, a conventional electronic commerce service requires that the seller should pack 100 pieces of items and then separately send them to buyers through international cargo services. Additionally, if tariffs are imposed on these items, each individual buyer should clear goods through customs personally.

However, the group purchase service method of this invention shown in FIG. 5 not only realizes the global group purchase on first-come-first-served basis through online, but also collectively performs international distribution processes including delivery and tariff through offline. Namely, sellers may receive orders from buyers and then sell the ordered items to a marketplace, and the marketplace may bear all responsibilities for international distribution processes such as purchase, delivery and tariff on behalf of sellers. In this case, the central server or the seller device may entrust at least one of delivery and tariff tasks to the local servers. In this embodiment, the group purchase service method may reduce the burden on sellers and buyers and also save distribution cost by performing distribution processes such as mass purchase, delivery and tariff for the same item in the same nation/region.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A group purchase service system comprising:
local servers respectively located in different service areas;
buyer devices each of which accesses the local server in the service area and performs a purchase process for a desired item through the local server; and
a central server configured to determine a discount policy such that each local server applies differential discount rates to group purchase rounds depending on group purchase volumes of the item in the purchase process performed by the buyer devices, and to apply a final discount rate according to a totalization of the group purchase volumes in all the service areas when a predefined sales deadline arrives or when all the items sold out.

2. The system of claim 1, wherein the final discount rate is greater than or equal to the differential discount rates.

3. The system of claim 1, wherein each of the local servers applies the differential discount rates whenever each of the group purchase volumes predetermined for the rounds is exceeded.

4. The system of claim 1, wherein the central server equally applies the final discount rate to all purchases of the item when the totalization of the group purchase volumes reaches a given value.

5. The system of claim 1, wherein the service areas are defined relying on at least of nations, regions, specific service zones of network operators, and marketplaces.

6. The system of claim 1, wherein the group purchase volumes are totalized on first-come-first-served basis according to the service areas or individual buyers.

7. The system of claim 1, further comprising:
seller devices each of which accesses the local server in the service area and registers the item in the local server.

8. The system of claim 7, wherein one of the central server and the seller device entrusts at least one of delivery and tariff tasks for the item to the local servers.

9. A group purchase service method comprising:
at a central server, determining a discount policy such that each local server applies differential discount rates in group purchase rounds depending on group purchase volumes of an item in a purchase process performed by buyer devices;
when each of the buyer devices accesses the local server in each service area and performs the purchase process for the item through the local server, at the local server, applying the differential discount rates to the rounds depending on the group purchase volumes of the item;
at the central server, determining whether a predefined sales deadline arrives and whether all the items sold out; and
when the sales deadline arrives or when all the items sold out, at the central server, applying a final discount rate according to a totalization of the group purchase volumes in all the service areas.

10. The method of claim 9, wherein the final discount rate is greater than or equal to the differential discount rates.

11. The method of claim 9, wherein each of the local servers applies the differential discount rates whenever each of the group purchase volumes predetermined for the rounds is exceeded.

12. The method of claim 9, wherein the central server equally applies the final discount rate to all purchases of the item when the totalization of the group purchase volumes reaches a given value.

13. The method of claim 9, wherein the service areas are defined relying on at least of nations, regions, specific service zones of network operators, and marketplaces.

14. The method of claim 9, wherein the group purchase volumes are totalized on first-come-first-served basis according to the service areas or individual buyers.

15. The method of claim 9, further comprising:
when each of seller devices accesses the local server in the service area and registers the item in the local server, at the central server, receiving item registration information from the local server.

16. The method of claim 15, further comprising:
at one of the central server and the seller device, entrusting at least one of delivery and tariff tasks for the item to the local servers.
